(19) United States
(12) Patent Application Publication
(10) Pub. No.: US 2007/0154716 A1
(43) Pub. Date: Jul. 5, 2007

(54) Composite material

(75) Inventors: Pawel Czubarow, Wellesley, MA (US); Mark W. Beltz, Attleboro, MA (US); Gwo Swei, Vandalia, OH (US); Oh-Hun Kwon, Westborough, MA (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 11/324,013

(22) Filed: Dec. 30, 2005

(51) Int. Cl. B32B 9/04

(52) U.S. Cl. 428/411.1

(57) ABSTRACT

A composite material includes polyimide and at least about 55 wt % non-carbonaceous filler. The composite material has a tensile strength at least about 44.9 MPa.

### FIELD OF THE DISCLOSURE

This disclosure, in general, relates to composite materials, devices formed thereof and methods of forming such composite materials and devices.

### BACKGROUND

Increasingly, industries, such as the aerospace, the automotive, and the electronics industries, are seeking strong, light weight, low cost materials that have high modulus, high compressive strength, or high wear resistance and are machinable for use in applications, such as bearing cages, electronic tooling, mandrels, hydraulic high pressure seals and other components. Such applications generally use light weight materials that are machinable or may be formed into intricate shapes. Other applications seek low cost, strong materials that have electrostatic dissipative properties.

As devices become increasing complex and component sizes decrease, the devices become more difficult to form. In addition, manufacturing of such devices uses intricate processing tools that may be difficult to form from metal. Conventionally, manufacturers have turned to ceramic materials or metal matrix composites for use in manufacturing such devices.

While ceramic materials tend to have high Young's modulus, high wear resistance, and dimensional stability at high temperatures, ceramic materials may be difficult and costly to form and machine into intricate tools and components useful in electronic devices. Typically, formation of ceramic components includes densification performed at high temperatures, often exceeding 1200° C. Once formed, typical ceramics exhibit high density and increased hardness, in some instances exceeding 11 GPa Vicker's hardness, making it difficult to machine detail into ceramic components.

More recently, manufacturers have turned to composite materials including polymer materials, and, in particular, polyolefin, polyamideimide, acetal, polytetrafluoroethylene, or polyimide. While such materials may be easier to form into tooling and electronic components, such polymeric materials typically exhibit poor mechanical properties and poor physical properties relative to ceramic materials. For example, such polymeric materials often exhibit unacceptably low tensile strength and high coefficients of thermal expansion, limiting the applications in which such materials may be useful. Further, such polymeric materials exhibit poor mechanical property retention after exposure to high temperatures. In addition, such polymeric materials often use glass fibers, carbon fibers, carbon black, or graphite. When machined into intricate components having small feature sizes, such materials may form flaws.

As such, an improved composite material would be desirable.

### SUMMARY

In a particular embodiment, a composite material includes polyimide and at least about 55 wt % non-carbonaceous filler. The composite material has a tensile strength at least about 44.9 MPa.

In another exemplary embodiment, a composite material includes polyimide and at least about 55 wt % non-carbonaceous filler. The composite material has a coefficient of thermal expansion not greater than about 30 ppm/° C.

In a further exemplary embodiment, a composite material includes polyimide and a non-carbonaceous filler. The composite material has a tensile strength at least about 44.9 MPa and has a coefficient of thermal expansion not greater than about 30 ppm/° C.

In an additional embodiment, a composite material includes polyimide and at least about 55 wt % non-carbonaceous filler. The composite material has a tensile strength performance of at least about 0.9 relative to the tensile strength of the polyimide absent non-carbonaceous filler.

In another exemplary embodiment, a composite material includes polyimide. The composite material has a tensile strength performance of at least about 0.9 relative to the tensile strength of the polyimide absent the non-carbonaceous filler and has a Young's modulus of at least about 2.5 GPa at 200° C.

In a further exemplary embodiment, a composite material includes polyimide and at least about 55 wt % non-carbonaceous filler. The non-carbonaceous filler has an average particle size not greater than about 1000 nm.

### BRIEF DESCRIPTION OF THE DRAWINGS

The present disclosure may be better understood, and its numerous features and advantages made apparent to those skilled in the art by referencing the accompanying drawings.

FIGS. 1 and 2 include illustrations of exemplary polymer matrices including dispersed non-carbonaceous filler.

FIG. 3 includes an illustration of a polymer matrix including agglomerated particulate.

FIG. 4 includes an illustration of the influence of non-carbonaceous filler loading on tensile strength.

### DESCRIPTION OF THE DRAWINGS

In a particular embodiment, a component is formed of a composite material including a polyimide matrix and a non-carbonaceous filler dispersed in the polyimide matrix. The composite material exhibits a coefficient of thermal expansion not greater than about 30 ppm/° C. and a tensile strength at least about 44.9 MPa. In an example, the non-carbonaceous filler is a particulate material having an average particle size not greater than about 5 microns, and, in particular, not greater than about 1 micron. In another example, the composite material includes at least about 20 wt % non-carbonaceous filler.

In a further exemplary embodiment, a method of forming a composite material includes preparing a mixture including a polyamic acid precursor and a non-carbonaceous filler. The polyamic acid precursor reacts to form polyamic acid. The method further includes dehydrating or imidizing the polyamic acid to form a polyimide matrix in which the non-carbonaceous filler is dispersed.

The polyamic acid precursor includes a chemical species that may react with itself or another species to form a polyamic acid, which may be dehydrated to form polyimide. In particular, the polyamic acid precursor may be one of a dianhydride or a diamine. Dianhydride and diamine may react to form polyamic acid, which may be imidized to form polyimide.

In an exemplary embodiment, the polyamic acid precursor includes dianhydride, and, in particular, aromatic dianhydrides. An exemplary dianhydride includes pyromellitic dianhydride (PMDA), 2,3,6,7-naphthalenetetracarboxylic acid dianhydride, 3,3′,4,4′-diphenyltetracarboxylic acid dianhydride, 1,2,5,6-naphthalenetetracarboxylic acid dianhydride, 2,2′,3,3′-diphenyltetracarboxylic acid dianhydride, 2,2-bis-(3,4-dicarboxyphenyl)-propane dianhydride, bis-(3,4-dicarboxyphenyl)-sulfone dianhydride, bis-(3,4-dicarboxyphenyl)-ether dianhydride, 2,2-bis-(2,3-dicarboxyphenyl)-propane dianhydride, 1,1-bis-(2,3-dicarboxyphenyl)-ethane dianhydride, 1,1-bis-(3,4-dicarboxyphenyl)-ethane dianhydride, bis-(2,3-dicarboxyphenyl)-methane dianhydride, bis-(3,4-dicarboxyphenyl)-methane dianhydride, 3,4,3′,4′-benzophenonetetracarboxylic acid dianhydride or a mixture thereof. In a particular example, the dianhydride is pyromellitic dianhydride (PMDA). In another example, the dianhydride is benzophenonetetracarboxylic acid dianhydride (BTDA) or diphenyltetracarboxylic acid dianhydride (BPDA).

In another exemplary embodiment, the polyamic acid precursor includes diamine. An exemplary diamine includes oxydianiline, 4,4′-diaminodiphenylpropane, 4,4′-diaminodiphenylmethane, 4,4′-diaminodiphenylamine, benzidine, 4,4′-diaminodiphenyl sulfide, 4,4′-diaminodiphenyl sulfone, 3,3′-diaminodiphenyl sulfone, 4,4′-diaminodiphenyl ether, bis-(4-aminophenyl)diethylsilane, bis-(4-aminophenyl)-phenylphosphine oxide, bis-(4-aminophenyl)-N-methylamine, 1,5-diaminonaphthalene, 3,3′-dimethyl-4,4′-diaminobiphenyl, 3,3′-dimethoxybenzidine, 1,4-bis-(p-aminophenoxy)-benzene, 1,3-bis-(p-aminophenoxy)-benzene, m-phenylenediamine (MPD), p-phenylenediamine (PPD) or a mixture thereof. In a particular example, the diamine is oxydianiline (ODA). In another example, the diamine is m-phenylenediamine (MPD) or p-phenylenediamine (PPD).

The polyamic acid precursors, and, in particular, a dianhydride and a diamine, may react to form polyamic acid, which is imidized to form polyimide. The polyimide forms a polymer matrix of a composite material in which a filler may be dispersed.

The filler is generally non-carbonaceous. Carbonaceous materials are those materials, excluding polymer, that are formed predominantly of carbon (or organic materials processed to form predominantly carbon), such as graphite, amorphous carbon, diamond, carbon fibers, and fullerenes. Non-carbonaceous materials typically refer to inorganic materials, which are carbon free or, if containing carbon, the carbon is covalently bonded to a cation, such as in the form of a metal carbide material (i.e., carbide ceramic). In an example, the non-carbonaceous filler includes a metal oxide, a metal sulfide, a metal nitride, a metal boride, a metal carbide, or a semiconductor having a desirable resistivity. Metal is intended to include metals and semi-metals, including semi-metals of groups 13, 14, 15, and 16 of the periodic table. For example, the non-carbonaceous filler may be a carbide or an oxide of a metal. In a particular example, the non-carbonaceous filler is an oxide of a metal.

A particular non-carbonaceous filler may include NiO, FeO, MnO, Co₂O₃, Cr₂O₃, CuO, Cu₂O, Fe₂O₃, Ga₂O₃, In₂O₃, GeO₂, MnO₂, TiO₂₋ₓ, RuO₂, Rh₂O₃, V₂O₃, Nb₂O₅, Ta₂O₅, WO₃, SnO₂, ZnO, CeO₂, TiO₂₋ₓ, ITO (indium-tin oxide), MgTiO₃, CaTiO₃, BaTiO₃, SrTiO₃, LaCrO₃, LaFeO₃, LaMnO₃, YMnO₃, MgTiO₃F, FeTiO₃, SrSnO₃, CaSnO₃, LiNbO₃, Fe₃O₄, MgFe₂O₄, MnFe₂O₄, CoFe₂O₄, NiFe₂O₄ ZnFe₂O₄, Fe₂O₄, CoFe₂O₄, FeAl₂O₄, MnAl₂O₄, ZnAl₂O₄, ZnLa₂O₄, FeAl₂O₄, MgIn₂O₄, MnIn₂O₄, FeCr₂O₄, NiCr₂O₄, ZnGa₂O₄, LaTaO₄, NdTaO₄, BaFe₁₂O₁₉, 3Y₂O₃.5Fe₂O₃, Bi₂Ru₂O₇, B₄C, SiC, TiC, Ti(CN), Cr₄C, VC, ZrC, TaC, WC, Si₃N₄, TiN, Ti(ON), ZrN, HfN, TiB₂, ZrB₂, CaB₆, LaB₆, NbB₂, MoSi₂, ZnS, Doped-Si, doped SiGe, III-V, II-VI semiconductors, or a mixture thereof. For example, the non-carbonaceous filler may include a single oxide of the general formula MO, such as NiO, FeO, MnO, CO₂O₃, Cr₂O₃, CuO, Cu₂O, Fe₂O₃, Ga₂O₃, In₂O₃, GeO₂, MnO₂, TiO₂₋ₓ, RuO₂, Rh₂O₃, V₂O₃, Nb₂O₅, Ta₂O₅, or WO₃. In another example, the non-carbonaceous filler may include a doped oxide, such as SnO₂, ZnO, CeO₂; TiO₂₋ₓ, or ITO (indium-tin oxide). In a further example, the non-carbonaceous filler may include a perovskite material, such as MgTiO₃, CaTiO₃, BaTiO₃, SrTiO₃, LaCrO₃, LaFeO₃, LaMnO₃, YMnO₃, MgTiO₃F, FeTiO₃, SrSnO₃, CaSnO₃, or LiNbO₃. In an additional example, the non-carbonaceous filler may include a spinel material, such as Fe₃O₄, MgFe₂O₄, MnFe₂O₄, CoFe₂O₄, NiFe₂O₄ ZnFe₂O₄, Fe₂O₄, CoFe₂O₄, FeAl₂O₄, MnAl₂O₄, ZnAl₂O₄, ZnLa₂O₄, FeAl₂O₄, MgIn₂O₄, MnIn₂O₄, FeCr₂O₄, NiCr₂O₄, ZnGa₂O₄, LaTaO₄, or NdTaO₄. In another example, the non-carbonaceous filler may include a magnetoplumbite material, such as BaFe₁₂O₁₉. In a further example, the non-carbonaceous filler may include a garnet material, such as 3Y₂O₃.5Fe₂O₃. In an additional example, the non-carbonaceous filler may include other oxides, such as Bi₂Ru₂O₇. In another example, the non-carbonaceous filler may include a carbide material having the general formula MC, such as B₄C, SiC, TiC, Ti(CN), Cr₄C, VC, ZrC, TaC, or WC. In a particular example, the non-carbonaceous filler includes SiC. In a further example, the non-carbonaceous filler may include a nitride material having the general formula MN, such as Si₃N₄, TiN, Ti(ON), ZrN, or HfN. In an additional example, the non-carbonaceous filler may include a boride, such as TiB₂, ZrB₂, CaB₆, LaB₆, NbB₂. In another example, the non-carbonaceous filler may include a silicide such as MoSi₂, a sulfide such as ZnS, or a semiconducting material such as doped-Si, doped SiGe, III-V, II-VI semiconductors. In a particular example, the non-carbonaceous filler includes an oxide of iron, such as Fe₂O₃. In another particular example, the non-carbonaceous filler includes an oxide of copper, such as CuO and Cu₂O. In addition, mixtures of these fillers may be used to further tailor the properties of the resulting composite materials, such as resistivity, surface resistance, and mechanical properties. Further properties may be influenced by doping oxides with other oxides or by tailoring the degree of non-stoichiometric oxidation.

In particular embodiments, the non-carbonaceous filler may act to modify the resistivity of the composite material. In such an embodiment, the non-carbonaceous filler has a desirable resistivity. In an exemplary embodiment, the non-carbonaceous filler has a resistivity of about 1.0×10⁻² ohm cm to about 1.0×10⁷ ohm cm, such as about 1.0 ohm cm to about 1.0×10⁵ ohm cm. Particular examples, such as iron oxides and copper oxides have resistivities of about 1×10² to about 1×10⁵ ohm cm.

In general, the non-carbonaceous filler includes particulate material. In an example, the particulate material has an average particle size not greater than about 100 microns, such as not greater than about 45 microns or not greater than about 5 microns. For example, the particulate material may have an average particle size not greater than about 1000 nm, such as not greater than about 500 nm or not greater than about 150 nm. In a particular example, the average particle size of the particulate may be at least about 10 nm, such as at least about 50 nm.

In a particular embodiment, the particular material has a low aspect ratio. The aspect ratio is an average ratio of the longest dimension of a particle to the second longest dimension perpendicular to the longest dimension. For example, the particulate material may have an average aspect ratio not greater than about 2.0, such as not greater than about 1.5, or about 1.0. In a particular example, the particulate material is generally spherical.

In an exemplary embodiment, the composite material includes at least about 20 wt % non-carbonaceous filler. For example, the composite material may include at least about 40 wt % non-carbonaceous filler, such as at least about 55 wt %, at least about 65 wt %, at least about 70 wt %, or at least about 75 wt % non-carbonaceous filler. However, too much filler may adversely influence physical, electrical, and mechanical properties. As such, the composite material may include not greater than about 95 wt % non-carbonaceous filler, such as not greater than about 90 wt % or not greater than about 85 wt % non-carbonaceous filler.

In another exemplary embodiment, the composite material may include small amounts of a second filler, such as a metal oxide. In particular, the polyimide matrix may include less than about 5.0 wt % of an oxide of boron, phosphorous, antimony or tungsten. Further, the composite material may include a coupling agent, a wetting agent, or a surfactant. In a particular embodiment, the composite material is free of coupling agents, wetting agents, and surfactants.

In a particular embodiment, the composite material may exhibit desirable surface resistivity and surface resistance. In an exemplary embodiment, the composite material exhibits a surface resistivity of about 1.0×10⁵ ohm/sq to about 1.0×10¹² ohm/sq. For example, the composite material may exhibit a surface resistivity of about 1.0×10⁵ ohm/sq to about 1.0×10⁹ ohm/sq, such as about 1.0×10⁵ ohm/sq to about 1.0×10⁷ ohm/sq. In an exemplary embodiment, the composite material exhibits a surface resistance not greater than about 1.0×10¹² ohms, such as not greater than about 5.0×10⁷ ohms. For example, the composite material may exhibit a surface resistance not greater than about 5.0×10⁶ ohms, such as not greater than about 1.0×10⁶ ohms. In a particular embodiment, the surface resistance is not greater than about 9.0×10⁵ ohms. In addition, the composite material may exhibit a desirable volume resistivity. In an exemplary embodiment, the composite material exhibits a volume resistivity not greater than about 1.0×10⁸ ohm cm, such as not greater than about 5.0×10⁶ ohm cm. For example, the volume resistivity may be not greater than about 1.0×10⁵ ohm cm. Typically, the volume resistivity is about 1.0×10⁴ to about 10×10¹¹ ohm cm, such as about 1.0×10⁴ to about 1.0×10⁸ ohm cm or about 1.0×10⁴ to about 5.0×10⁶ ohm cm.

In particular embodiments, the composite material is used in components that undergo large temperature changes and may operate at high temperatures over extended time periods. As such, the composite material desirably has a low coefficient of thermal expansion and high temperature stability. In an example, the coefficient of thermal expansion (CTE) of the composite material is not greater than about 30 ppm/C when measured from 25° C. to 250° C. For example, the CTE of the composite material may be not greater than about 25 ppm/C, such as not greater than about 20 ppm/° C. In addition, the composite material may exhibit a glass transition temperature (T_{g}) at least about 300° C., such as at least about 330° C. or at least about 340° C. The glass transition temperature may be measured using dynamic mechanical thermal analysis (DMA). In an example, DMA is performed using a DMA Q800 by TA Instruments under the conditions: amplitude 15 microns, frequency 1 Hz, air atmosphere, and a temperature program increasing from room temperature to 600° C. at a rate of 5° C./min. Further, the composite material may be rated for intermittent operation at temperatures at least about 460° C., such as at least about 482° C.

The composite material may also exhibit desirable mechanical properties. For example, the composite material may have a desirable tensile strength relative to the polyimide absent the non-carbonaceous filler. In an exemplary embodiment, the composite material has a tensile strength performance, defined as the ratio of the tensile strength of the composite material to the tensile strength of the polyimide absent the non-carbonaceous filler, of at least about 0.6. For example, the composite material may have a relative strength performance of at least about 0.8, or, in particular, at least about 0.9, such as at least about 0.95, at least about 1.0, at least about 1.25, or at least about 1.5. In an embodiment, the composite material may exhibit a tensile strength of at least about 44.8 MPa (6500 psi). In an example, the tensile strength of the composite material is at least about 58.6 MPa (8500 psi), such as at least about 63.3 MPa (9200 psi), at least about 66.1 MPa (9600 psi), or at least about 72.3 MPa (10500 psi). Particular examples exhibit tensile strength of at least about 86.18 MPa (12,500 psi). In an additional example, the elongation at break of the composite material may be at least about 0.5%, such as at least about 0.7%. The tensile strength and elongation may, for example, be determined using a standard technique, such as ASTM D6456 using specimens conforming to D1708 and E8.

In another example, the composite material may exhibit a Young's modulus of at least about 2.5 GPa at 200° C. For example, at 200° C., the Young's modulus of the composite material may be at least about 5.0 GPa, such as at least about 6.5 GPa, at least about 6.8 GPa, or at least about 7.0 GPa. At room temperature (about 25° C.), the Young's modulus of the composite material may be at least about 20 GPA, such as at least about 30 GPa or at least about 40 GPa. In addition, the composite material may exhibit a Vicker's hardness of at least about 0.25 GPa. In an example, the Vicker's hardness of the composite material is at least about 0.30 GPa, such as at least about 0.35 GPa. In a further example, the Vicker's hardness is not greater than about 1.0 GPa.

In an exemplary method, the composite material is formed by preparing a mixture including unreacted polyamic acid precursors and a non-carbonaceous filler. In a particular example, the mixture includes the non-carbonaceous filler and at least one of a dianhydride and a diamine. The mixture may further include a solvent or a blend of solvents.

A solvent may be selected whose functional groups do not react with either of the reactants to any appreciable extent. In addition to being a solvent for the polyamic acid, the solvent is typically a solvent for at least one of the reactants (e.g., the diamine or the dianhydride). In a particular embodiment, the solvent is a solvent for both of the diamine and the dianhydride.

The solvent may be a polar solvent, a non-polar solvent or a mixture thereof. In one exemplary embodiment, the solvent is an aprotic dipolar organic solvent. An exemplary aprotic dipolar solvent includes N,N-dialkylcarboxylamide, N,N-dimethylformamide, N,N-dimethylacetamide, N,N-diethylformamaide, N,N-diethylacetamide, N,N-dimethylmethoxyacetamide, N-methyl caprolactam, dimethylsulfoxide, N-methyl-2-pyrrolidone, tetramethyl urea, pyridine, dimethylsulfone, hexamethylphosphoramide, tetramethylene sulfone, formamide, N-methylformamide, butylrolactone, or a mixture thereof. An exemplary non-polar solvent includes benzene, benzonitrile, dioxane, xylene, toluene, cyclohexane or a mixture thereof. Other exemplary solvents are of the halohydrocarbon class and include, for example, chlorobenzene.

In one exemplary embodiment, the solvent solution includes a mixture of at least two solvents. The solvent ratio may result from mixing prior to adding reactant, may result from combining two reactant mixtures, or may result from addition of solvents or water entraining components during various parts of the process. In one exemplary embodiment, the resulting solvent mixture, such as the solvent mixture during polyamic acid imidization, includes an aprotic dipolar solvent and a non-polar solvent. The aprotic dipolar solvent and non-polar solvent may form a mixture having a ratio of 1:9 to 9:1 aprotic dipolar solvent to non-polar solvent, such as 1:3 to 6:1. For example, the ratio may be 1:1 to 6:1, such as 3.5:1 to 4:1 aprotic dipolar solvent to non-polar solvent.

Depending on the polyimide formation process, the solvent may be added prior to polyamic acid polymerization, during polyamic acid polymerization, after polyamic acid polymerization, during polyimide formation, after polyimide formation, or a combination thereof. For solution formed polyimide, reactants may be provided in solvent solutions or added to solvent solutions. Additional solvents may be added prior to dehydration or imidization, such as prior to azeotropic distillation. For precipitation formed polyimide, reactants may be provided in solvents or added to solvents. Polyimide may be precipitated from the solvent mixture through addition of dehydrating agents.

According to an embodiment, the non-carbonaceous filler may be added along with at least one polyamic acid precursor to solvent prior to polymerization of the polyamic acid precursors. The addition may be performed under high shear conditions. In a particular embodiment, the non-carbonaceous filler may be milled, such as through ball milling, prior to addition to the mixture. In another exemplary embodiment, the non-carbonaceous filler may be heat treated in a dry atmosphere prior to adding to the mixture. For example, the non-carbonaceous filler may be heat treated in a nitrogen atmosphere for about 2 hours at about 700° C. Generally, the mixture including the non-carbonaceous filler and the polyamic acid precursor in solvent has a Hegman grind gauge reading not greater than 5 microns, such as not greater than 1 micron.

In an exemplary method, a second polyamic acid precursor may be added to the mixture either in the form of a second mixture or as a dry component. For example, the polyamic acid mixture may be prepared by reacting a diamine component with a dianhydride component. In an exemplary embodiment, the dianhydride component is added to a solvent mixture including the diamine component. In another exemplary embodiment, the dianhydride component is mixed with the diamine without solvent to form a dry mixture. Solvent is added to the dry mixture in measured quantities to control the reaction and form the polyamide mixture. In such an example, the non-carbonaceous filler may be mixed with the dry mixture prior to addition of the solvent. In a further exemplary embodiment, a mixture including diamine and a solvent is mixed with a second mixture including the dianhydride component and a solvent to form the polyamide mixture. The non-carbonaceous filler may be included in one or both of the mixtures.

In general, the polyamic acid reaction is exothermic. As such, the mixture may be cooled to control the reaction. In a particular embodiment, the temperature of the mixture may be maintained or controlled at about −10° C. to about 100° C., such as about 25° C. to about 70° C.

The polyamic acid may be dehydrated or imidized to form polyimide. The polyimide may be formed in solution from the polyamic acid mixture. For example, a Lewis base, such as a tertiary amine, may be added to the polyamic acid mixture and the polyamic acid mixture heated to form a polyimide mixture. Portions of the solvent may act to form azeotropes with water formed as a byproduct of the imidization. In an exemplary embodiment, the water byproduct may be removed by azeotropic distillation. See, for example, U.S. Pat. No. 4,413,117 or U.S. Pat. No. 3,422,061.

In another exemplary embodiment, polyimide may be precipitated from the polyamic acid mixture, for example, through addition of a dehydrating agent. Exemplary dehydrating agents include fatty acid anhydrides formed from acetic acid, propionic acid, butyric acid, or valeric acid, aromatic anhydrides formed from benzoic acid or napthoic acid, anhydrides of carbonic acid or formic acid, aliphatic ketenes, or mixtures thereof. See, for example, U.S. Pat. No. 3,422,061.

In general, the polyimide product forms solids that are typically filtered, washed, and dried. For example, polyimide precipitate may be filtered and washed in a mixture including methanol, such as a mixture of methanol and water. The washed polyimide may be dried at a temperature between about 150° C. and about 300° C. for a period between 5 and 30 hours and, in general, at or below atmospheric pressure, such as partial vacuum (500-700 torr) or full vacuum (50-100 torr). As a result, a composite material is formed including a polyimide matrix having non-carbonaceous filler dispersed therein. The non-carbonaceous filler is generally evenly dispersed, providing substantially regionally invariant resistive properties.

To form an article, the composite material may be hot pressed or press sintered. In another example, the composite material may be pressed and subsequently sintered to form the component. For example, the polyimide may be molded using high pressure sintering at temperatures of about 250° C. to about 450° C., such as about 350° C. and pressures at least about 351 kg/cm² (5 ksi), such as about 351 kg/cm² (5 ksi) to about 1406 kg/cm² (20 ksi) or, in other embodiments, as high as about 6250 kg/cm² (88.87 ksi).

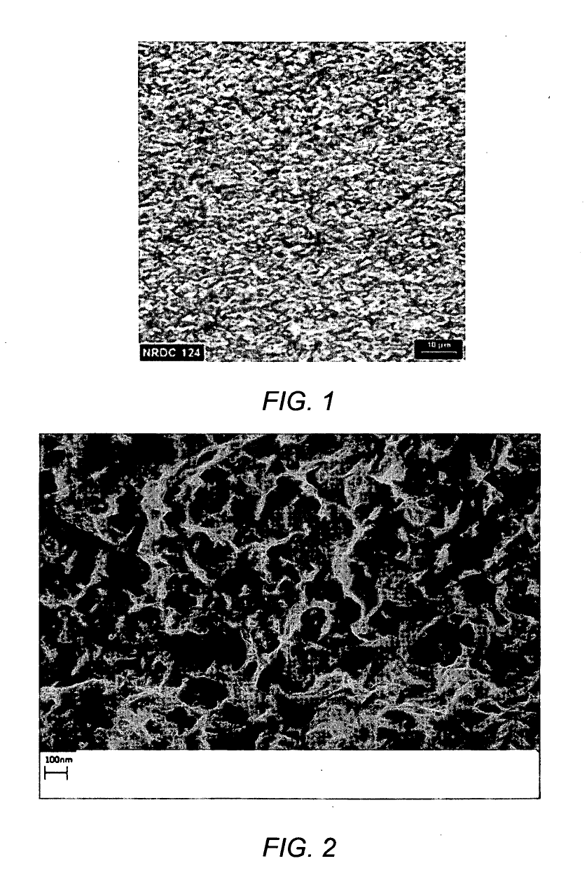

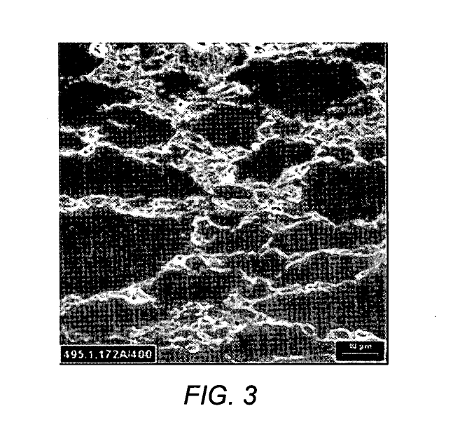

As illustrated in FIG. 1, the SEM image of a polished cross section of the resulting article exhibits a dispersed non-carbonaceous filler and is substantially free of non-carbonaceous filler agglomerates. Such substantially agglomerate free dispersion provides substantially invariant properties. FIG. 2 includes an SEM image at higher magnification of a highly loaded composite. The dispersed non-carbonaceous filler is separated by polymer and does not form agglomerates. In contrast FIG. 3 illustrates the SEM image of a polished cross section of a sintered composite material formed by blending particulate material with the polymer after imidization. As illustrated in FIG. 3, post-imidization blending of particulate material results in agglomerate formation and can lead to property variation between regions.

### EXAMPLES

Samples are prepared from mixtures including filler and pyromellitic dianhydride (PMDA) and oxydianiline (ODA). The polyamic acid product of PMDA and ODA is imidized through azeotropic distillation. The composite material, including polyimide and dispersed filler, is formed into test samples through hot pressing.

Table 1 illustrates the coefficient of thermal expansion (CTE) and surface resistance of samples formed of a variety of fillers. Those samples denoted with an “M” superscript include filler that is ball milled prior to addition to the mixture and those samples denoted with a “T” include heat-treated non-carbonaceous filler. In general, those samples including at least 20 wt % non-carbonaceous filler exhibit improved CTE. For example, Samples 1, 4, 9, 10, and 11 exhibit CTE not greater than 30 ppm/° C., and, in particular, samples 9, 10, 11 exhibit CTE not greater than 20 ppm/° C. In addition, particular samples exhibit surface resistance not greater than 5.0E7 ohms. For example, samples 9, 10, and 11 exhibit surface resistance not greater than 1.0E6 ohms.

TABLE 1
Effect of Filler on CTE and Surface Resistance

| | | CTE | Molded Surface |
|---|---|---|---|
| | | (ppm/° C.) | Resistance |
| Sample | Filler | RT-200° C. | (Ohm) |
| 1 | 60 wt % Si | 26 | 2.2E7 |
| 2 | 51 wt % MoS₂ | 46 | 4.7E10 |
| 3 | 44 wt % SiC | 40 | 4.5E11 |
| 4^{M} | 71 wt % SiC | 20 | 6E11 |
| 5^{T} | 50 wt % TiO₂ | 41 | 7.8E10 |
| 6^{T} | 57 wt % Fe₂O₃ | 35 | 2.5E8 |
| 7^{M} | 57 wt % Fe₂O₃ | 44 | 4.9E7 |
| 8 | 57 wt % Fe₂O₃ | 42 | 1.2E8 |
| 9 | 79 wt % Fe₂O₃ | 16 | 8.5E5 |
| 10 | 85 wt % Fe₂O₃ | 12 | 4.1E5 |
| 11^{M} | 79 wt % Fe₂O₃ | 19 | 3.5E5 |

^{M}Filler ball milled
^{T}Filler heat treated in N₂ at 700° C. prior to polymerization

In addition to reduced coefficient of thermal expansion, particular samples exhibit improved hardness relative to ESD commercial polymer products Semitron® S420 and Pomalux® SD-A. Specifically, samples 9, 10, and 11 exhibit hardness at least about 0.30 GPa and, typically, at least about 0.35 GPa.

TABLE 2
Hardness of Samples Relative to Commercial Products

| | CTE | |
|---|---|---|
| Material | (ppm/° C.) | Hardness (GPa) |
| Sample 6 | 35 | 0.216 |
| Sample 8 | 42 | 0.269 |
| Sample 9 | 16 | 0.386 |
| Sample 10 | 12 | 0.395 |
| Sample 11 | 19 | 0.495 |
| Meldin 7001 | 50 | 0.148 |
| Semitron ® | 50 | 0.300 |
| S420 ® | | |
| Pomalux ® SD-A | 200 | 0.08 |

### Example 2

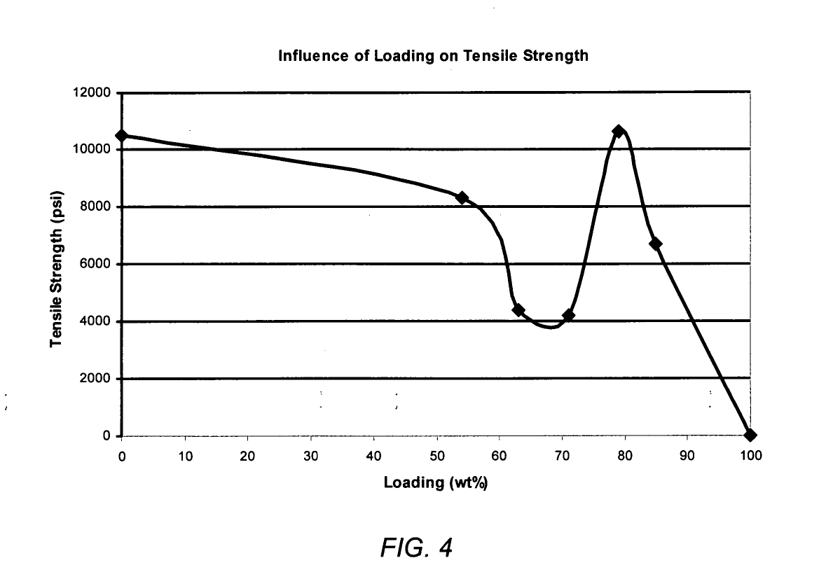

In particular examples, non-carbonaceous filler loading influences properties, such as CTE and tensile strength. FIG. 4 illustrates the affect of loading on tensile strength. In particular, FIG. 4 represents the tensile strength of samples including a weight percent of particulate iron oxide having a primary particle size of 100 nm. The highly loaded polyimide including 79 wt % iron oxide exhibits tensile strength as high as virgin polyimide, greater than 73.08 MPa (10,600 psi) on average and samples as high as 86.18 MPa (12,500 psi). In addition, the Young's modulus at 200° C. of samples including 55 wt % and 79 wt % iron oxide are 3 GPa and 7 GPa, respectively. At room temperature (about 25° C.), a sample including 79 wt % iron oxide has a Young's modulus of 42.05 GPa (6100 ksi). Further such composites exhibit qualities similar to graphite when machining. For example, a wall thickness of less than 15 mils may be machined into the composite.

### Example 3

In a further example, a composite material including 79 wt % copper I oxide is formed in accordance with EXAMPLE 1. At room temperature, the sample exhibits a tensile strength of 63.5 MPa (9208 psi) and a Young's modulus of 21.4 GPa (3111 ksi). The sample has a specific gravity of 3.623.

Particular embodiments of the above-disclosed composite materials advantageously exhibit low coefficient of thermal expansion and high tensile strength performance. While not intending to be limited to a particular theory, it is believed that the homogeneity of the dispersion of the non-carbonaceous filler and a filler/polyimide complex contributes to improved mechanical properties. Such dispersions and complexes may be produced as a result of including the non-carbonaceous filler in the pre-reacted mixture with at least one of the polymer precursors prior to polymerization of the polymer precursors.

While the invention has been illustrated and described in the context of specific embodiments, it is not intended to be limited to the details shown, since various modifications and substitutions can be made without departing in any way from the scope of the present invention. For example, additional or equivalent substitutes can be provided and additional or equivalent production steps can be employed. As such, further modifications and equivalents of the invention herein disclosed may occur to persons skilled in the art using no more than routine experimentation, and all such modifications and equivalents are believed to be within the scope of the invention as defined by the following claims.

1. A composite material comprising polyimide and at least about 55 wt % non-carbonaceous filler, the composite material having a tensile strength at least about 44.9 MPa.

2. The composite material of claim 1, wherein the tensile strength is at least about 58.6 MPa.

3.-6. (canceled)

7. The composite material of claim 1, wherein the composite material has a tensile strength performance at least about 0.9 relative to the polyimide absent the non-carbonaceous filler.

8.-11. (canceled)

12. The composite material of claim 1, wherein the composite material comprises at least about 65 wt % of the non-carbonaceous filler.

13. (canceled)

14. The composite material of claim 1, wherein the composite material comprises not greater than about 95 wt % of the non-carbonaceous filler.

15. The composite material of claim 14, wherein the composite material comprises not greater than about 90 wt % of the non-carbonaceous filler.

16. (canceled)

17. The composite material of claim 1, wherein the composite material has a Young's modulus of at least about 2.5 GPa at 200° C.

18.-21. (canceled)

22. The composite material of claim 1, wherein the composite material has a Young's modulus of at least about 20.0 GPa at 25° C.

23. The composite material of claim 1, wherein the composite material has a volume resistivity of about 1.0×10⁴ ohm cm to about 1.0×10⁸ ohm cm.

24. The composite material of claim 23, wherein the volume resistivity is not greater than about 5.0×10⁶ ohm cm.

25. The composite material of claim 24, wherein the volume resistivity is not greater than about 1.0×10⁵ ohm cm.

26.-28. (canceled)

29. The composite material of claim 1, wherein the composite material has an elongation of at least about 0.5%.

30. (canceled)

31. The composite material of claim 1, wherein the composite material has a coefficient of thermal expansion not greater than about 30 ppm/° C.

32.-33. (canceled)

34. The composite material of claim 1, wherein the non-carbonaceous filler is selected from the group consisting of NiO, FeO, MnO, CO₂O₃, Cr₂O₃, CuO, Cu₂O, Fe₂O₃, Ga₂O₃, In₂O₃, GeO₂, MnO₂, TiO₂₋ₓ, RuO₂, Rh₂O₃, V₂O₃, Nb₂O₅, Ta₂O₅, WO₃, SnO₂, ZnO, CeO₂, TiO₂₋ₓ, ITO (indium-tin oxide), MgTiO₃, CaTiO₃, BaTiO₃, SrTiO₃, LaCrO₃, LaFeO₃, LaMnO₃, YMnO₃, MgTiO₃F, FeTiO₃, SrSnO₃, CaSnO₃, LiNbO₃, Fe₃O₄, MgFe₂O₄, MnFe₂O₄, CoFe₂O₄, NiFe₂O₄ ZnFe₂O₄, Fe₂O₄, CoFe₂O₄, FeAl₂O₄, MnAl₂O₄, ZnAl₂O₄, ZnLa₂O₄, FeAl₂O₄, MgIn₂O₄, MnIn₂O₄, FeCr₂O₄, NiCr₂O₄, ZnGa₂O₄, LaTaO₄, NdTaO₄, BaFe₁₂O₁₉, 3Y₂O₃.5Fe₂O₃, Bi₂Ru₂O₇, B₄C, SiC, TiC, Ti(CN), Cr4C, VC, ZrC, TaC, WC, Si₃N₄, TiN, Ti(ON), ZrN, HfN, TiB₂, ZrB₂, CaB₆, LaB₆, NbB₂, MoSi₂, ZnS, Doped-Si, doped SiGe, III-V, II-VI semiconductors, and a mixture thereof.

35. (canceled)

36. The composite material of claim 1, wherein the non-carbonaceous filler is a metal oxide.

37. The composite material of claim 36, wherein the metal oxide is an oxide of iron.

38. The composite material of claim 36, wherein the metal oxide is an oxide of copper.

39. (canceled)

40. The composite material of claim 1, wherein the non-carbonaceous filler has an average particle size not greater than 1 micron.

41.-42. (canceled)

43. The composite material of claim 1, wherein the polyimide is the imidized product of a dianhydride and a diamine.

44.-45. (canceled)

46. A composite material comprising polyimide and at least about 55 wt % non-carbonaceous filler, the composite material having a coefficient of thermal expansion not greater than about 30 ppm/° C.

47. The composite material of claim 46, wherein the coefficient of thermal expansion is not greater than about 25 ppm/° C.

48.-57. (canceled)

58. The composite material of claim 46, wherein the composite material has a tensile strength performance of at least about 0.9 relative to the polyimide absent the non-carbonaceous filler.

59.-77. (canceled)

78. A composite material comprising polyimide and at least about 55 wt % non-carbonaceous filler, the composite material having a tensile strength performance of at least about 0.9 relative to the tensile strength of the polyimide absent non-carbonaceous filler.

79. The composite material of claim 78, wherein the tensile strength performance is at least about 0.95.

80.-106. (canceled)
